(19) United States
(12) Patent Application Publication
(10) Pub. No.: US 2024/0170786 A1
(43) Pub. Date: May 23, 2024

(54) BATTERY MODULE, BATTERY PACK, AND VEHICLE

(71) Applicant: Scania CV AB, Södertälje (SE)

(72) Inventors: Magdalena CEDERLÖF, Järna (SE); Karolina LÄNTA, Hägersten (SE); Alvaro SANCHEZ EXPOSITO, Vega (SE); Adam ANDERSSON, Järna (SE)

(73) Assignee: Scania CV AB, Södertälje (SE)

(21) Appl. No.: 18/283,997

(22) PCT Filed: Apr. 7, 2022
(86) PCT No.: PCT/SE2022/050349

§ 371 Date: Sep. 25, 2023

(30) Foreign Application Priority Data
Apr. 26, 2021 (SE) 2150526-8

(51) Int. Cl. H01M 50/249; B60K 1/04; H01M 10/625; H01M 10/658; H01M 50/209; H01M 50/224; H01M 50/258; H01M 50/262

(52) U.S. Cl. CPC H01M 50/249; B60K 1/04; H01M 10/625; H01M 10/658; H01M 50/209; H01M 50/224; H01M 50/258; H01M 50/262; H01M 2220/20

(57) ABSTRACT

A battery module for a vehicle is disclosed. The battery module comprises a casing configured to accommodate a number of battery cells and a mounting section configured to receive a fastening element for mounting the battery module to a further component of the vehicle. The battery module comprises a thermal insulation unit positioned between the casing and the mounting section. The present disclosure further relates to a battery pack for a vehicle and a vehicle comprising a battery pack.

### TECHNICAL FIELD

The present disclosure relates to a battery module for a vehicle. The present disclosure further relates to a battery pack for a vehicle comprising a number of battery modules and a vehicle comprising a battery pack.

### BACKGROUND

The use of electric drive for vehicles provides many advantages, especially regarding local emissions. Such vehicles comprise one or more electric propulsion motors configured to provide motive power to the vehicle. These types of vehicles can be divided into the categories pure electric vehicles and hybrid electric vehicles. Pure electric vehicles, sometimes referred to as battery electric vehicles, only-electric vehicles, and all-electric vehicles, comprise a pure electric powertrain and comprise no internal combustion engine and therefore produce no emissions in the place where they are used.

A hybrid electric vehicle comprises two or more distinct types of power, such as an internal combustion engine and an electric propulsion system. The combination of an internal combustion engine and an electric propulsion system provides advantages with regard to energy efficiency, partly because of the poor energy efficiency of an internal combustion engine at lower power output levels. Moreover, some hybrid electric vehicles are capable of operating in pure electric drive when wanted, such as when driving in certain areas.

The electricity is usually stored in a battery pack comprising a number of rechargeable battery cells. Some different types of battery cells are used, such as lithium-ion batteries, lithium polymer batteries, and nickel-metal hydride batteries. A problem associated with propulsion batteries is that most types of batteries, such as those listed above, are temperature sensitive meaning that they have a temperature range in which they are most efficient. Moreover, too high temperatures and too low temperatures may damage and/or reduce the lifetime of the propulsion battery. In addition, too high temperatures and too low temperatures may reduce the energy storing capacity of the battery cells of the battery which can have a negative impact on the available operational range of the vehicle.

A battery cell generates heat internally upon charging and discharging. Moreover, vehicles can operate in various temperature conditions which affects the temperature of the battery cells. Therefore, and for the above given reasons, the temperature of a propulsion battery is preferably regulated by a thermal management system. A thermal management system may be configured to cool battery cells in some operational conditions, such as during or after high charge or discharge levels of the battery cells and/or during high ambient temperatures. Moreover, a thermal management system may be configured to heat battery cells in some other operational conditions, such as when a vehicle is started and the temperature of the battery cells is below a threshold temperature, and the like. In some vehicles, and especially in pure electric vehicles, the thermal management system may utilize electric energy stored in the battery cells for operating the thermal management system, at least on some occasions such as when an electric system of the vehicle is not connected to a power grid. Thus, if so, the operation of the thermal management system may have a negative impact on the available operational range of the vehicle.

A further problem associated with propulsion batteries is swelling of battery cells. That is, the temperature of a battery cell and the state of charge (SOC) thereof, may affect the volume of the battery cell. Moreover, other aspects may also affect the volume of a battery cell, such as anode to cathode stoichiometric ratios, particulate contamination, mechanical damage, accelerated parasitic reactions between the electrodes and electrolyte, with release of heat and gases, and the like. If the battery cell is mounted in a confined space which does not allow expansion of the battery cell, the internal pressure inside the battery cell may become dangerously high. Moreover, the structure in which the battery cell is arranged may become damaged upon swelling of battery cells.

Another problem associated with propulsion batteries is that battery cells may be mechanically sensitive, meaning that the battery cells preferably are protected from vibration, impact, high forces, and the like. However, batteries mounted to a vehicle operate in a demanding environment and are usually subjected to a lot of vibration, forces, and the like.

In addition, even though electric drive for vehicles can provide many advantages regarding energy efficiency of vehicles, the carbon footprint thereof, and the like, the efficient use of energy is also an important aspect for vehicles comprising an electric propulsion system.

Furthermore, generally, on today's consumer market, it is an advantage if products, such as vehicles and associated components, systems, and arrangements, have conditions and/or characteristics suitable for being manufactured and assembled in a cost-efficient manner.

### SUMMARY

It is an object of the present invention to overcome, or at least alleviate, at least some of the above-mentioned problems and drawbacks.

According to a first aspect of the invention, the object is achieved by a battery module for a vehicle. The battery module comprises a casing configured to accommodate a number of battery cells. The battery module further comprises a mounting section configured to receive a fastening element for mounting the battery module to a further component of the vehicle. The battery module comprises a thermal insulation unit positioned between the casing and the mounting section.

Since the battery module comprises a thermal insulation unit positioned between the casing and the mounting section, the transfer of heat between the casing and the mounting section is reduced. As a further result, the transfer of heat between battery cells arranged in the casing and the further component is also reduced.

Thereby, a thermal management system of the vehicle is allowed to operate in a more efficient manner with a reduced leakage of heat between the battery cells and the further component. As a further result thereof, conditions are provided for regulating the temperature of the battery cells to more ideal temperature ranges in an energy efficient manner. Thereby, conditions are also provided for prolonging an available operational range of a vehicle comprising the battery module and increasing a total energy efficiency of the vehicle. In addition, because conditions are provided for regulating the temperature of the battery cells to more ideal temperature ranges, the life length of the battery cells can also be increased.

Moreover, studies have shown that the outermost battery cells in a battery module may have a different temperature than other battery cells of a battery module during operation of a vehicle. That is, battery cells are normally stacked side by side to form a row of battery cells inside a battery module. The battery cells at the respective ends of the row, i.e. battery cells arranged near or adjacent to the casing of the battery module, may have different temperature characteristics than other battery cells of the battery module due to leakage of heat to the casing of the battery module. Thus, by reducing the transfer of heat between the casing and the mounting section, a more even temperature of battery cells inside the battery module can be obtained. As a further result thereof, conditions are provided for increasing the life length of the battery cells inside the battery module.

Furthermore, due to the thermal insulation unit positioned between the casing and the mounting section, the battery module may have an improved ability to allow swelling of battery cells inside the battery module. This is because the thermal insulation unit may compress when swelling of battery cells inside the battery module causes movement of a wall of the casing towards the mounting section.

Moreover, due to the thermal insulation unit positioned between the casing and the mounting section, the battery module may have an improved ability to protect battery cells arranged inside the battery module from mechanical impact, vibration, and the like. This is because the thermal insulation unit may act as a protective barrier between the mounting section and the casing.

In addition, a battery module is provided having conditions and characteristics suitable for being manufactured and assembled in a cost-efficient manner. This is because an assembler, or an assembling machine may simply position the thermal insulation unit between the casing and the mounting section when assembling the battery module to thermally insulate the casing from the mounting section.

Accordingly, a battery module is provided overcoming, or at least alleviating, at least some of the above-mentioned problems and drawbacks. As a result, the above-mentioned object is achieved.

Optionally, the thermal insulation unit is made of a polymeric material. Thereby, a thermal insulation unit is provided having conditions for high thermal insulation properties while having conditions and characteristics suitable for being manufactured and assembled in a cost-efficient manner.

In addition, the battery module may have an improved ability to allow swelling of battery cells inside the battery module. This is because the polymeric thermal insulation unit may have an improved ability to compress when swelling of battery cells inside the battery module causes movement of a wall of the casing towards the mounting section.

Moreover, the battery module may have an improved ability to protect battery cells arranged inside the battery module from mechanical impact, vibration, and the like. This is because a thermal insulation unit made of a polymeric material may have an improved ability to act as a protective barrier between the mounting section and the casing.

Optionally, the thermal insulation unit is made of a fibre reinforced material. Thereby, a strong and durable thermal insulation unit can be provided in a cost-efficient manner.

Optionally, the mounting section comprises a mounting element comprising a through hole for receiving the fastening element. Thereby, a simple and efficient mounting section is provided allowing a quick and cost-efficient assembly of the battery module.

Optionally, the through hole extends along a first direction, and wherein the thermal insulation unit is configured to transfer forces between the mounting element and the casing in directions substantially perpendicular to the first direction during movement of a vehicle comprising the battery module. Thereby, a battery module is provided having an improved ability to protect battery cells inside the battery module from mechanical impact, vibration, and the like. This is because the thermal insulation unit may act as a protective barrier between the mounting section and the casing in an efficient manner so as to reduce transfer of mechanical impact, vibration, and the like, between the mounting section and the casing of the battery module.

Optionally, the mounting element is elongated and extends along a first direction, and wherein the length of the mounting element, measured along the first direction, is more than 30% of the length of the casing measured along the first direction. Thereby, conditions are provided for mounting the battery module to the further component of the vehicle in a rigid, durable, and reliable manner while ensuring a low transfer of heat between the casing and the mounting section of the battery module.

Optionally, the first direction substantially coincides with a vertical direction of the vehicle when the battery module is mounted on a vehicle and the vehicle is positioned onto a flat horizontal surface. Thereby, conditions are provided for a rigid, durable, and reliable mounting of the battery module to the further component of the vehicle while ensuring a low transfer of heat between the casing and the mounting section of the battery module.

Optionally, the thermal insulation unit is configured to support at least part of the load exerted by the battery module on the further component during tilting of a vehicle comprising the battery module. Thereby, conditions are provided for a rigid, durable, and reliable mounting of the battery module to the further component of the vehicle while ensuring a low transfer of heat between the casing and the mounting section of the battery module.

Optionally, the casing is made of a metal material. Thereby, a strong and durable battery module can be provided while ensuring a low transfer of heat between the casing and the mounting section of the battery module.

Optionally, the battery module comprises a number of corners, and wherein the battery module comprises a mounting section at each corner of the battery module. Thereby, conditions are provided for a rigid, durable, and reliable mounting of the battery module to the further component of the vehicle while ensuring a low transfer of heat between the casing and a mounting section of the battery module.

Optionally, the battery module comprises a thermal insulation unit positioned between each mounting section of the battery module and the casing. Thereby, a battery module is provided having conditions for even lower transfer of heat between battery cells arranged in the casing and the further component. Thereby, a thermal management system of the vehicle is allowed to operate in an even more efficient manner with a reduced leakage of heat between the battery cells and the further component. In addition, a more even temperature of battery cells inside the battery module can be obtained.

Furthermore, due to the thermal insulation unit positioned between each mounting section of the battery module and the casing, the battery module may have an improved ability to allow swelling of battery cells inside the battery module. This is because the thermal insulation units may compress when swelling of battery cells inside the battery module causes movement of a wall of the casing towards the mounting sections.

Moreover, due to the thermal insulation unit positioned between each mounting section of the battery module and the casing, the battery module may have a further improved ability to protect battery cells arranged inside the battery module from mechanical impact, vibration, and the like. This is because the thermal insulation units may act as a protective barrier between the mounting section and the casing.

In addition, a battery module is provided having conditions and characteristics suitable for being manufactured and assembled in a cost-efficient manner. This is because an assembler, or an assembling machine may simply position the thermal insulation units between the casing and the mounting sections when assembling the battery module to thermally insulate the casing from the mounting sections.

Optionally, the further component is another battery module or a casing of a battery pack comprising a number of battery modules. Thereby, a battery module is provided having conditions for a low transfer of heat between battery cells arranged in the casing and another battery module and/or the casing of a battery pack.

According to a second aspect of the invention, the object is achieved by a battery pack for a vehicle, wherein the battery pack comprises a number of battery modules according to some embodiments of the present disclosure.

Since the battery pack comprises a number of battery modules according to some embodiments, a battery pack is provided having conditions for reduced internal transfer of heat. Thereby, a thermal management system of the vehicle is allowed to operate in a more efficient manner. As a further result thereof, conditions are provided for regulating the temperature of the battery cells of the battery pack to more ideal temperature ranges in an energy efficient manner. Thereby, conditions are also provided for prolonging an available operational range of a vehicle comprising the battery pack and increasing a total energy efficiency of the vehicle. In addition, because conditions are provided for regulating the temperature of the battery cells to more ideal temperature ranges, the life length of the battery cells of the battery pack can also be increased.

Moreover, a battery pack is provided having conditions for a more even temperature of battery cells inside the battery pack. As a further result thereof, conditions are provided for increasing the life length of the battery cells inside the battery pack.

Furthermore, a battery pack is provided having conditions for an improved ability to allow swelling of battery cells inside the battery pack.

Moreover, a battery pack is provided having conditions for an improved ability to protect battery cells arranged inside the battery pack from mechanical impact, vibration, and the like.

In addition, a battery pack is provided having conditions and characteristics suitable for being manufactured and assembled in a cost-efficient manner.

Accordingly, a battery pack is provided overcoming, or at least alleviating, at least some of the above-mentioned problems and drawbacks. As a result, the above-mentioned object is achieved.

Optionally, the battery pack is configured to provide electricity to an electric propulsion motor of the vehicle. Thereby, an efficient battery pack can be provided for supplying electricity to the electric propulsion motor of the vehicle.

According to a third aspect of the invention, the object is achieved by a vehicle comprising an electric propulsion motor configured to provide motive power to the vehicle, and wherein the vehicle further comprises a battery pack according to some embodiments of the present disclosure.

Since the vehicle comprises a battery pack according to some embodiments, a vehicle is provided overcoming, or at least alleviating, at least some of the above-mentioned problems and drawbacks. As a result, the above-mentioned object is achieved.

Further features of, and advantages with, the present invention will become apparent when studying the appended claims and the following detailed description.

### BRIEF DESCRIPTION OF THE DRAWINGS

Various aspects of the invention, including its particular features and advantages, will be readily understood from the example embodiments discussed in the following detailed description and the accompanying drawings, in which:

FIG. 1 illustrates a vehicle according to some embodiments of the present disclosure,

FIG. 2 illustrates a perspective view of the battery pack of the vehicle illustrated in FIG. 1,

FIG. 3 illustrates a top view of one of the battery modules of the battery pack illustrated in FIG. 2,

FIG. 4 illustrates an exploded view of some components of the battery module illustrated in FIG. 3,

FIG. 5 illustrates the components illustrated in FIG. 4 in an assembled state,

FIG. 6 illustrates a top view of the components illustrated in FIG. 5, and

FIG. 7 illustrates a cross section through a portion of the battery pack illustrated in FIG. 2.

### DETAILED DESCRIPTION

Aspects of the present invention will now be described more fully. Like numbers refer to like elements throughout. Well-known functions or constructions will not necessarily be described in detail for brevity and/or clarity.

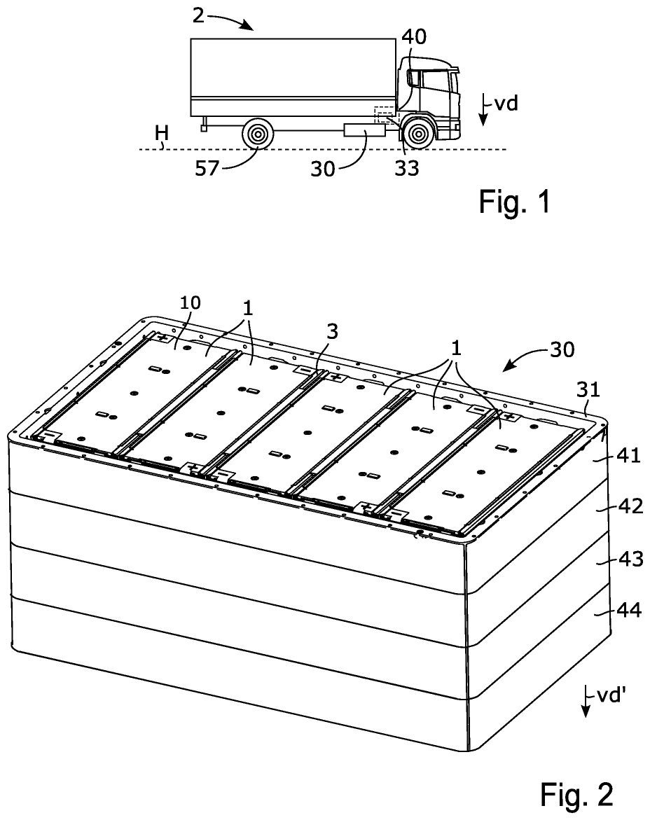

FIG. 1 illustrates a vehicle 2, according to some embodiments of the present disclosure. According to the illustrated embodiments, the vehicle 2 is a truck, i.e. a type of heavy vehicle. According to further embodiments, the vehicle 2, as referred to herein, may be another type of heavy or lighter type of manned or unmanned vehicle for land or water based propulsion such as a lorry, a bus, a construction vehicle, a tractor, a car, a ship, a boat, or the like.

The vehicle 2 comprises an electric powertrain 40. According to the illustrated embodiments, the electric powertrain 40 is configured to provide motive power to the vehicle 2 via wheels 57 of the vehicle 2. The electric powertrain 40 comprises an electric propulsion motor 33. The electric propulsion motor 33 is capable of providing motive power to the vehicle 2 via wheels 57 of the vehicle 2 as well as providing regenerative braking of the vehicle 2. Thus, according to the illustrated embodiments, the electric propulsion motor 33 is capable of operating as an electric motor as well as an electric generator. The electric propulsion motor 33 of the vehicle 2 may also be referred to as a vehicle propulsion motor/generator.

According to the illustrated embodiments, the electric powertrain 40 of the vehicle 2 is a pure electric powertrain 40, i.e. a powertrain comprising no internal combustion engine. According to further embodiments, the electric powertrain 40 of the vehicle 2 may be a so called hybrid electric powertrain 40 comprising a combustion engine in addition to the electric propulsion motor 33 for providing motive power to the vehicle 2.

Moreover, in FIG. 1, a battery pack 30 of the vehicle 2 is indicated. The battery pack 30 is operably connected to the electric propulsion motor 33 and is configured to provide electricity thereto and/or to receive electricity therefrom. As is further explained herein, the battery pack 30 comprises a number of battery cells arranged in battery modules of the battery pack 30.

In FIG. 1, the vehicle 2 is illustrated as positioned onto a flat horizontal surface H in an intended use position. Moreover, in FIG. 1, a vertical direction vd of the vehicle 2 is indicated. The vertical direction vd of the vehicle 2 is perpendicular to the flat horizontal surface H when the vehicle 2 is positioned thereon in the intended use position. Moreover, the vertical direction vd of the vehicle 2 coincides with a local gravity vector at the location of the vehicle 2 when the vehicle 2 positioned onto a flat horizontal surface H in an intended use position.

FIG. 2 illustrates a perspective view of the battery pack 30 of the vehicle 2 illustrated in FIG. 1. As can be seen in FIG. 2, the battery pack 30 comprises a number of battery modules 1. In more detail, according to the illustrated embodiments, the battery pack 30 comprises a casing 31 comprising four casing layers 41-44. According to the embodiments illustrated in FIG. 2, each casing layer 41-44 comprises five battery modules 1, wherein the battery modules 1 are mounted to the casing layers 41-44 of the casing 31 of the battery pack 30, as is further explained herein.

Thus, according to the embodiments illustrated in FIG. 2, the battery pack 30 comprises twenty battery modules 1 in total. However, according to further embodiments, the battery pack 30, as referred to herein, may comprise another number of casing layers 41-44 than four and another number of battery modules 1 per casing layer 41-44 than five. Accordingly, the battery pack 30, as referred to herein, may comprise another number of battery modules 1 than twenty. As examples, the battery pack 30, as referred to herein may comprise a number of casing layers 41-44 within the range of 1-8 casing layers 41-44, wherein each casing layer 41-44 of the battery pack 30 may comprise a number of battery modules 1 within the range of 1-8 battery modules 1.

In FIG. 2, a vertical direction vd′ of the battery pack 30 is indicated. Below, simultaneous reference is made to FIG. 1 and FIG. 2, if not indicated otherwise. According to the illustrated embodiments, the battery pack 30 is configured to be mounted to the vehicle 2 such that the vertical direction vd′ of the battery pack 30 coincides with the vertical direction vd of the vehicle 2 when the vehicle 2 is positioned onto a flat horizontal surface H in an intended use position. As can be seen in FIG. 2, according to the illustrated embodiments, the casing layers 41-44 of the casing 31 of the battery pack 30 are stacked on top of each other along the vertical direction vd′ of the battery pack 30.

However, according to further embodiments, the casing layers 41-44 of the casing 31 of the battery pack 30 may be stacked and attached to each other along another direction. Moreover, the battery pack 30 may be configured to be mounted to the vehicle 2 in another orientation than in the above described. The battery pack 30 may comprise one or more mounting portions for mounting the battery pack 30 to the vehicle 2. The battery pack 30 may for example be mounted to a chassis or frame of a vehicle 2 for example using one or more fastening elements. Moreover, the battery pack 30 may comprise a lid covering the top portion of the battery pack 30. However, such a lid and such mounting portions of the battery pack 30 are not illustrated in FIG. 2 for reasons of brevity and clarity.

As can be seen in FIG. 2, each battery module 1 comprises a lid 10. However, only the lid 10 of one of the battery modules 1 has been provided with the reference sign “10” in FIG. 2 for reasons of brevity and clarity.

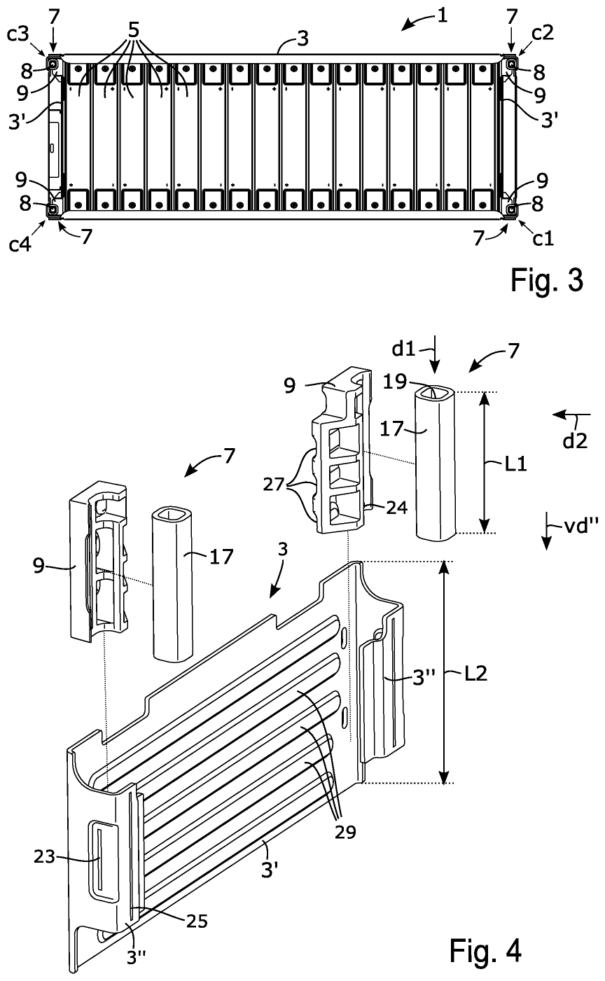

FIG. 3 illustrates a top view of one of the battery modules 1 of the battery pack 30 illustrated in FIG. 2. In FIG. 3, the lid of the battery module 1 has been removed for reasons of visibility and clarity. The battery module 1 comprises a casing 3 accommodating a number of battery cells 5. The battery cells 5 may for example be lithium-ion battery cells, lithium polymer battery cells, or nickel-metal hydride battery cells. The casing 3 of the battery module 1 may also be referred to as a battery module casing 3. Likewise, with reference to FIG. 2, the casing 31 of the battery pack 30 may also be referred to as a battery pack casing 31.

According to the embodiments illustrated in FIG. 3, the battery module 1 comprises sixteen battery cells 5. According to further embodiments, the battery module 1 may comprise another number of battery cells 5, such as a number within the range of 1-30 battery cells 5, or a number within the range of 4-26 battery cells 5. Each battery cell 5 may be electrically connected to one or more other battery cells 5 of the battery module 1. As understood from the above described, according to the illustrated embodiments, the battery module 1 is configured to provide electricity to an electric powertrain of a vehicle comprising battery module 1. Likewise, with reference to FIG. 2, each battery module 1 may be electrically connected to one or more other battery modules 1 of the battery pack 30 so as to provide electricity to an electric powertrain of a vehicle comprising the battery pack 30.

The battery module 1 comprises a number of mounting sections 7. Each mounting section 7 of the battery module 1 is configured to receive a fastening element 8 for mounting the battery module 1 to a further component as is further explained herein. According to the illustrated embodiments, the further component, as referred to herein, is the casing 31 of the battery pack 30 illustrated in FIG. 2. According to further embodiments, the further component, as referred to herein, may be another type of component, such as another battery module 1.

As is indicated in FIG. 3, the battery module 1 comprises a number of corners c1-c4, wherein the battery module 1 comprises a mounting section 7 at each corner c1-c4 of the battery module 1. According to the illustrated embodiments, the battery module 1 comprises four corners c1-c4 and therefore also four mounting sections 7. However, the battery module 1 may comprise one or more mounting sections 7 arranged outside of the corners c1-c4 of the battery module 1. Moreover, the battery module 1 may comprise another number of corners c1-c4 than four, such as for example, three, five, six, or the like, and may comprise another number of mounting sections 7 per corner c1-c4 than one.

As is indicated in FIG. 3, according to the illustrated embodiments, the battery module 1 comprises a thermal insulation unit 9 positioned between each mounting section 7 of the battery module 1 and the casing 3. The thermal insulation unit 9 is made of a material having a lower thermal conductivity than the material of the mounting section 7 and the material of the casing 3 of the battery module 1. In this manner, the transfer of heat between the casing 3 and the mounting sections 7 is reduced. As a further result, the transfer of heat between battery cells 5 arranged in the casing 3 and the further component, i.e. the casing 31 of the battery pack 30 according to the illustrated embodiments, is also reduced. These advantages are also obtained if using one or more thermal insulating units 9 positioned between mounting sections 7 and the casing 3 of the battery module 1 because the transfer of heat between the casing 3 and the mounting sections 7 will be reduced. Thus, the battery module 1 may not necessarily comprise one thermal insulation unit 9 positioned between each mounting section 7 of the battery module 1 and the casing 3 as in the illustrated embodiments.

In FIG. 3, two side walls 3′ of the casing 3 of the battery module 1 are indicated. According to the illustrated embodiments, the battery module 1 has a rectangular shape wherein the side walls 3′ indicated in FIG. 3 constitute side walls 3′ of short sides of the battery module 1. However, the side wall 3′ referred to in the following may also be a side wall of a long side the battery module 1.

FIG. 4 illustrates an exploded view of some components 3′, 9, 17 of the battery module 1 illustrated in FIG. 3, including one of the side walls 3′ of the battery module 1. The opposing side walls 3′ of the battery module 1 illustrated in FIG. 3 may comprise the same or corresponding features, functions and advantages. Therefore, in the following, reference is made only to one of the side walls 3′ of the battery module 1. Below, simultaneous reference is made to FIG. 3 and FIG. 4 if not indicated otherwise.

In FIG. 4, two mounting sections 7 of the battery module 1 can be clearly seen. Each mounting section 7 comprises a mounting element 17. The mounting sections 7 and the mounting elements 17 of the battery module 1 may comprise the same features, functions, and advantages. Therefore, in some places below, reference is made to one of the mounting sections 7 and one of the mounting elements 17 of the battery module 1.

As can be clearly seen in FIG. 4, according to the illustrated embodiments, the mounting element 17 is elongated in a first direction d1. The mounting element 17 comprises a through hole 19 for receiving a fastening element, such as a fastening element 8 indicated in FIG. 3. The through hole 19 extends along the first direction d1. According to the illustrated embodiments, the mounting element 17 is formed as a tubular sleeve. According to further embodiments, the mounting element 17 may have a different shape. The side wall 3′ comprises bracket-like protrusions 3″ protruding a distance out from the side wall 3′. Moreover, in FIG. 4, two thermal insulating unit 9 can be seen. The mounting elements 17 may be attached to the side wall 3′ of the casing 3 of the battery module 1 by welding the mounting elements 17 to the side walls 3′. As is further explained herein, according to the illustrated embodiments, the mounting elements 17 are attached to the side wall 3′ of the casing 3 of the battery module 1 by welding the mounting elements 17 to the bracket-like protrusions 3″ along the lines 23, 25 indicated in FIG. 4.

As indicated above, FIG. 4 illustrates an exploded view of some components 3′, 9, 17 of the battery module 1 illustrated in FIG. 3. The components 3′, 9, 17 illustrated in FIG. 4 can be said to be illustrated in a dissembled state. According to the illustrated embodiments, the thermal insulating unit 9 comprises a number of grooves 27. The grooves 27 extend in directions transversal to the first direction d1 when the thermal insulating unit 9 and the mounting element 17 are attached to the side wall 3′, i.e. when the components 3′, 9, 17 are in an assembled state, as is further explained herein. Moreover, the side wall 3′ comprise a number of bulges 29 protruding out from the side wall 3′.

Furthermore, according to the illustrated embodiments, the thermal insulating unit 9 comprises an elongated recess 24. The elongated recess 24 is configured to accommodate at least a portion of the mounting element 17 when the thermal insulating unit 9 and the mounting element 17 are attached to the side wall 3′, as is further explained herein. Thus, as understood from the above, the elongated recess 24 is elongated in a direction coinciding with the first direction d1 when the thermal insulating unit 9 and the mounting element 17 are attached to the side wall 3′.

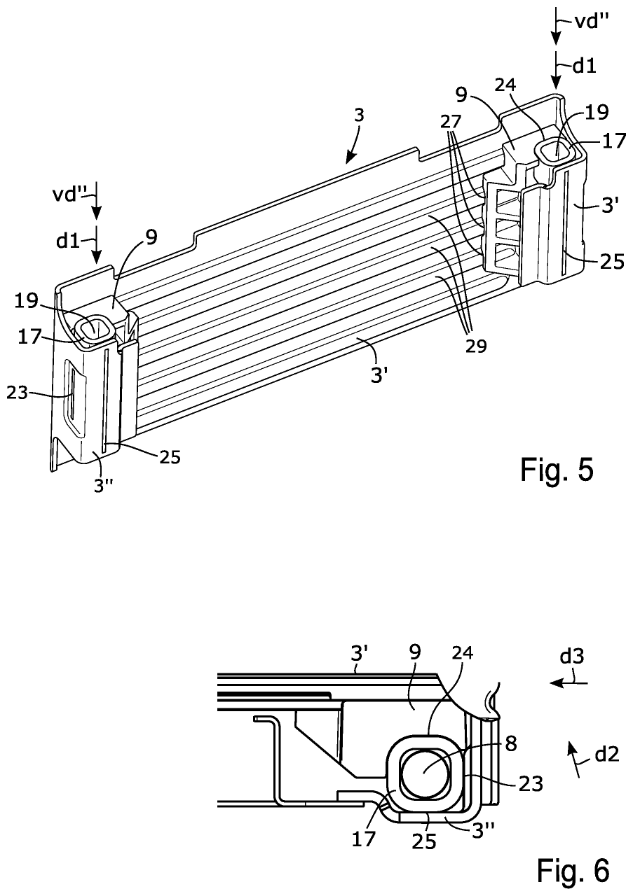

FIG. 5 illustrates the components 3′, 9, 17 illustrated in FIG. 4 in an assembled state. In the following, simultaneous reference is made to FIG. 3-FIG. 5 if not indicated otherwise. As can be clearly seen in FIG. 5, the bulges 29 of the side wall 3′ protrude into the grooves 27 of the thermal insulating unit 9 when the thermal insulating unit 9 and the mounting element 17 are attached to the side wall 3′. In this manner, the thermal insulating unit 9 is locked from moving in directions parallel to the first direction d1 by the abutting contact between the bulges 29 of the side wall 3′ and the grooves 27 of the thermal insulating unit 9.

In an assembling process of the battery module 1, an assembler, or an assembling machine, may position the thermal insulating unit 9 against the side wall 3′ of the battery module 1 such that the bulges 29 of the side wall 3′ protrude into the grooves 27 of the thermal insulating unit 9. The assembler, or the assembling machine, may then insert the mounting element 17 into a space formed between the elongated recess 24 of the thermal insulating unit 9 and the bracket like protrusion 3″ of the side wall 3′ of the battery module 1. The assembler, or the assembling machine, may then attach the mounting element 17 to the side wall 3′ of the battery module 1, for example by welding the mounting element 17 to the bracket like protrusion 3″ along the lines 23, 25 indicated in FIG. 4 and FIG. 5. The mounting element 17 may for example be welded to the bracket like protrusion 3″ along the lines 23, 25 using laser-welding. When the mounting element 17 is inserted into the space formed between the elongated recess 24 of the thermal insulating unit 9 and the bracket like protrusion 3″ of the side wall 3′, the thermal insulating unit 9 is also locked from moving in directions perpendicular to the first direction d1 due to the form of the elongated recess 24 of the thermal insulating unit 9 and the form of the mounting element 17.

According to further embodiments, the interface between the thermal insulating unit 9 and the side wall 3′ may comprise another type of structure for locking the thermal insulating unit 9 from moving relative to the side wall 3′ when the battery module 1 is in an assembled state. As an example, the thermal insulating unit 9 may comprise a number of bulges and the side wall 3′ may comprise a number of recesses, wherein the bulges of the thermal insulating unit 9 may protrude into the recesses of the side wall 3′ when the battery module 1 is in the assembled state. Furthermore, according to some embodiments, the thermal insulating unit 9 and the mounting element 17 may be attached to the battery module 1 in another manner than in the above described manner. As an example, the thermal insulating unit 9 and/or the mounting element 17 may be attached to the battery module 1 using gluing, welding, and/or using one or more fastening elements, such as screw, bolts, or the like.

FIG. 6 illustrates a top view of the components 3′, 9, 17 illustrated in FIG. 5. In FIG. 6, the components 3′, 9, 17 are illustrated in a viewing direction coinciding with the first direction d1 indicated in FIG. 5. As can be seen in FIG. 6, the thermal insulating unit 9 encloses a large proportion of the mounting element 17 and forms a barrier between the mounting element 17 and the side wall 3′ of the battery module 1.

In FIG. 6, a second direction d2 and a third direction d3 are indicated. Each of the second and third directions d2, d3 is perpendicular to the first direction d1 indicated in FIG. 5. Moreover, the third direction d3 is parallel to the side wall 3′ of the battery module. As can be clearly seen in FIG. 6, the thermal insulating unit 9 is locked from moving in directions parallel to the third direction d3 when the battery module is in the assembled state due to the form of the elongated recess 24 of the thermal insulating unit 9 and the form of the mounting element 17.

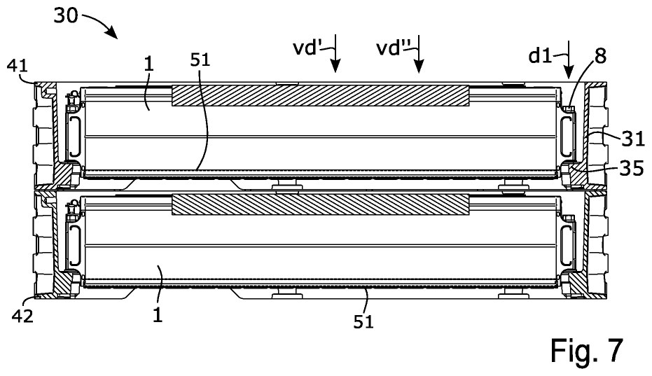

FIG. 7 illustrates a cross section of a portion of the battery pack 30 illustrated in FIG. 2. Below, simultaneous reference is made to FIG. 1-FIG. 7, if not indicated otherwise. As can be clearly seen in FIG. 7, according to the illustrated embodiments, the battery module 1 is configured to be mounted to a portion 35 of the casing 31 of the battery pack 30. The portion of the casing 31 of the battery pack 30 may comprise a hole provided with threads configured to engage with threads of the fastening element 8. In this manner, the battery module 1 can be mounted to the battery pack 30 in a simple, quick, and reliable manner. As is best seen in FIG. 7, according to the illustrated embodiments, the fastening element 8 is a bolt. According to further embodiments, the fastening element 8, as referred to herein, may be another type of fastening element, such as a screw, an elongated rod, or the like.

Moreover, as indicated above, due to the thermal insulating unit 9 positioned between the casing 3 of the battery module 1 and the mounting section 7, the transfer of heat between the casing 3 of the battery module 1 and the casing 31 of the battery pack 30 is reduced. Moreover, as is best seen in FIG. 6, the thermal insulation unit 9 may act as a protective barrier protecting battery cells 5 arranged inside the battery module 1 from mechanical impact, vibration, and the like, transferred to the battery module 1 via the mounting sections 7 thereof.

According to some embodiments of the present disclosure, the thermal insulation unit 9 is made of a polymeric material, such as polyamide. In this manner, a thermal insulation unit 9 is provided having conditions for high thermal insulation properties while having conditions and characteristics suitable for being manufactured and assembled in a cost-efficient manner. Moreover, a thermal insulating unit 9 is provided having conditions for a high ability to protect battery cells 5 arranged inside the battery module 1 from mechanical impact, vibration, and the like.

Furthermore, as is best seen in in FIG. 5, due to the features of the battery module 1 and the thermal insulating units 9 positioned between the casing 3 of the battery module 1 and the mounting sections 7, bending of the side wall 3′ is allowed to some degree in a direction towards the thermal insulating units 9. Thereby, the battery module 1 has an improved ability to allow swelling of battery cells 5 inside the battery module 1. This is because the thermal insulation units 9 may compress if swelling of battery cells 5 inside the battery module 1 causes movement of the side wall 3′ of the casing 3 towards the thermal insulating units 9.

According to some embodiments of the present disclosure, the thermal insulation unit 9 is made of a fibre reinforced material, such as a fibre reinforced polymeric material. The thermal insulating unit 9 may thus comprise fibres configured to reinforce the thermal insulating unit 9. In this manner, a strong and durable thermal insulating unit 9 can be provided in a cost-efficient manner. The fibres may for example comprise glass fibres.

According to the illustrated embodiments, the casing 3 and the mounting element 17 is made of a metal material, such as steel. Thereby, a strong and durable battery module 1 can be provided as well as a strong and durable attachment thereof to the casing 31 of the battery pack 30, while ensuring a low transfer of heat between the casing 3 of the battery module 1 and the casing 31 of the battery pack 30.

As explained with reference to FIG. 4 and FIG. 5 above, according to the illustrated embodiments, the mounting element 17 is elongated and extends along a first direction d1. Moreover, as is indicated in FIG. 4, according to the illustrated embodiments, the length L1 of the mounting element 17, measured along the first direction d1, is approximately 64% of the length L2 of the casing 3 measured along the first direction d1. The length L2 of the casing 3 measured along the first direction d1 may also be referred to as a hight of the casing 3.

According to further embodiments, the length L1 of the mounting element 17, measured along the first direction d1, may be within the range of 30%-110%, or may be within the range of 40%-90%, of the length L2 of the casing 3 measured along the first direction d1. Due to the considerable length L1 of the mounting element 17, a rigid and durable mounting of the battery module 1 can be ensured.

In FIG. 4, FIG. 5, and FIG. 7, a vertical direction vd″ of the battery module 1 is indicated. According to the illustrated embodiments, the vertical direction vd″ of the battery module 1 coincides with the vertical direction vd′ of the battery pack 30 when the battery module 1 is mounted to the battery pack 30 as is indicated in FIG. 7. As explained above, according to the illustrated embodiments, the battery pack 30 is configured to be mounted to the vehicle 2 such that the vertical direction vd′ of the battery pack 30 coincides with the vertical direction vd of the vehicle 2 when the vehicle 2 is positioned onto a flat horizontal surface H in an intended use position. Moreover, as is understood from the above, the vertical direction vd of the vehicle 2 coincides with the direction of a gravity vector at the location of a vehicle 2 when the vehicle 2 is positioned onto a flat horizontal surface H in an intended use position. Thus, according to the illustrated embodiments, the first direction d1, in which the mounting element 17 and the through hole 19 thereof extend, coincides with the vertical direction vd of the vehicle 2 when the vehicle 2 is positioned onto a flat horizontal surface H in an intended use position. According to some embodiments, the first direction d1, in which the mounting element 17 and the through hole 19 thereof extend, may substantially coincide with the vertical direction vd of the vehicle 2 when the vehicle 2 is positioned onto a flat horizontal surface H in an intended use position. According to such embodiments, the angle between the first direction d1 and the gravity vector at the location of a vehicle 2 comprising the battery pack 30 may be less than 12 degrees, or may be less than 7 degrees, when the vehicle 2 is positioned onto a flat horizontal surface H in an intended use position. However, according to further embodiments, the battery module 1 may be arranged in another manner and in another orientation relative to battery pack 30 comprising the battery module 1 as well as relative to a vehicle 2 comprising the battery module 1. Likewise, the battery pack 30 may be arranged in another orientation relative to the vehicle 2 than in the orientation according to the illustrated embodiments.

As best seen in FIG. 6, the thermal insulation unit 9 is configured to transfer forces between the mounting element 17 and the casing 3 in directions d2 substantially perpendicular to the first direction d1 during movement of a vehicle 2 comprising the battery module 1. Thus, according to the illustrated embodiments, the thermal insulation unit 9 will support at least part of the load exerted by the battery module 1 on the casing 31 of the battery pack 30 when the vehicle 2 comprising the battery module 1 is tilted relative to a horizontal plane. In addition, the thermal insulation unit 9 will support at least part of the load exerted by the battery module 1 on the casing 31 of the battery pack 30 upon acceleration and retardation of the vehicle 2.

In FIG. 7, two casing layers 41, 42 of the battery pack 30 can be seen. In more detail, according to the illustrated embodiments, the battery module 1 is mounted to a portion 35 of one layer 41 of the casing 31 of the battery pack 30. The casing layers 41, 42 of the battery pack 30 may be attached to each other using one or more fastening elements, welding, or the like. Moreover, in FIG. 7, two thermal regulating units 51 are schematically indicated. The thermal regulating units 51 are arranged in thermal contact with battery cells 5 inside the battery modules 1 and are configured to regulate the temperature of battery cells 5 arranged inside the battery modules 1. The thermal regulating units 51 may each comprise coolant channels configured to accommodate a coolant such as a water/glycol mixture, oil, or the like. The vehicle 2 comprising the battery pack 30 may comprise a battery thermal management system configured to pump temperature controlled coolant through the coolant channels of the thermal regulating units 51 to regulate the temperature of battery cells 5 arranged inside the battery modules 1.

Due to the thermal insulating units 9 of the battery modules 1, the battery thermal management system of the vehicle 2 is allowed to operate in a more efficient manner with a reduced leakage of heat between the battery cells 5 and the casing 31 of the battery pack 30. Moreover, due to the thermal insulating units 9, conditions are provided for regulating the temperature of the battery cells 5 to more ideal temperature ranges in an energy efficient manner. Thereby, conditions are also provided for prolonging an available operational range of the vehicle 2 comprising the battery module 1 and increasing a total energy efficiency of the vehicle 2. In addition, because conditions are provided for regulating the temperature of the battery cells 5 to more ideal temperature ranges, the life length of the battery cells 5 can be increased.

Moreover, as can be seen in FIG. 3, according to the illustrated embodiments, the battery cells 5 are stacked side by side to form a row of battery cells 5 inside a battery module 1.

The battery cells 5 at the respective ends of the row, i.e. the battery cells 5 arranged near or adjacent to side walls 3′ of the casing 3 of the battery module 1, usually have different temperature characteristics than other battery cells 5 of the battery module 1. However, by reducing the transfer of heat between the casing 5 and the mounting section 7, a more even temperature of battery cells 5 inside the battery module 1 can be obtained. As a further result thereof, conditions are provided for increasing the life length of the battery cells 5 inside the battery module 1.

The feature that the through hole 19 extends along a first direction d1 means that a centre axis of the through hole coincides with the first direction d1. Likewise, the feature that the mounting element 17 is elongated in a first direction d1 means that a direction of elongation of the mounting element 17 coincides with the first direction d1 or is at least substantially parallel to the first direction d1. Furthermore, the feature that the elongated recess 24 is elongated in a direction coinciding with the first direction d1 means that a centre axis of the elongated recess 24 coincides with the first direction d1 or is at least substantially parallel to the first direction d1.

The wording “substantially coincides with”, as used herein, may encompass that the angle between the objects referred to is less than 12 degrees, or is less than 7 degrees.

The wording “substantially perpendicular to”, as used herein, may encompass that the angle between the objects referred to is within the range of 80-100 degrees, or is within the range of 85-95 degrees.

The wording “substantially parallel to”, as used herein, may encompass that the angle between the objects referred to is less than 7 degrees, or is less than 4 degrees.

It is to be understood that the foregoing is illustrative of various example embodiments and that the invention is defined only by the appended independent claims. A person skilled in the art will realize that the example embodiments may be modified, and that different features of the example embodiments may be combined to create embodiments other than those described herein, without departing from the scope of the present invention, as defined by the appended independent claims.

As used herein, the term “comprising” or “comprises” is open-ended, and includes one or more stated features, elements, steps, components, or functions but does not preclude the presence or addition of one or more other features, elements, steps, components, functions, or groups thereof.

1. A battery module for a vehicle, wherein the battery module comprises:
a casing configured to accommodate a number of battery cells; and
a mounting section configured to receive a fastening element for mounting the battery module to a further component of the vehicle, and
a thermal insulation unit positioned between the casing and the mounting section.

2. The battery module according to claim 1, wherein the thermal insulation unit is made of a polymeric material.

3. The battery module according to claim 1, wherein the thermal insulation unit is made of a fiber reinforced material.

4. The battery module according to claim 1, wherein the mounting section comprises a mounting element comprising a through hole for receiving the fastening element.

5. The battery module according to claim 4, wherein the through hole extends along a first direction, and wherein the thermal insulation unit is configured to transfer forces between the mounting element and the casing in directions substantially perpendicular to the first direction during movement of a vehicle comprising the battery module.

6. The battery module according to claim 4, wherein the mounting element is elongated and extends along a first direction, and wherein the length of the mounting element, measured along the first direction, is more than 30% of the length of the casing measured along the first direction.

7. The battery module according to claim 5, wherein the first direction substantially coincides with a vertical direction of the vehicle when the battery module is mounted on a vehicle and the vehicle is positioned onto a flat horizontal surface.

8. The battery module according to claim 1, wherein the thermal insulation unit is configured to support at least part of the load exerted by the battery module on the further component during tilting of a vehicle comprising the battery module.

9. The battery module according to claim 1, wherein the casing is made of a metal material.

10. The battery module according to claim 1, wherein the battery module comprises a number of corners, and wherein the battery module comprises a mounting section at each corner of the battery module.

11. The battery module according to claim 1, wherein the battery module comprises a thermal insulation unit positioned between each mounting section of the battery module and the casing.

12. The battery module according to claim 1, wherein the further component is another battery module or a casing of a battery pack comprising a number of battery modules.

13. A battery pack for a vehicle, wherein the battery pack comprises a number of battery modules, wherein each module:
a casing configured to accommodate a number of battery cells; and
a mounting section configured to receive a fastening element for mounting the battery module to a further component of the vehicle; and
a thermal insulation unit positioned between the casing and the mounting section.

14. The battery pack according to claim 13, wherein the battery pack is configured to provide electricity to an electric propulsion motor of the vehicle.

15. A vehicle comprising an electric propulsion motor configured to provide motive power to the vehicle, and wherein the vehicle further comprises at least one
a battery module for a vehicle, wherein the battery module comprises:
a casing configured to accommodate a number of battery cells; and
a mounting section configured to receive a fastening element for mounting the battery module to a further component of the vehicle; and
a thermal insulation unit positioned between the casing and the mounting section.
